(19) United States
(12) Patent Application Publication
(10) Pub. No.: US 2010/0168269 A1
(43) Pub. Date: Jul. 1, 2010

(54) RADIATION AND CHEMICAL CURABLE COATING COMPOSITION

(75) Inventor: Gia Huynh-Ba, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. Du Pont De Nemours And Company, Wilmington (DE)

(21) Appl. No.: 12/676,390

(22) PCT Filed: Sep. 17, 2008
(86) PCT No.: PCT/US08/76600

§ 371 Date: Mar. 4, 2010

Related U.S. Application Data
(60) Provisional application No. 60/994,329, filed on Sep. 17, 2007.

(51) Int. Cl. C08L 75/14; C08F 2/46

(52) U.S. Cl. 522/174; 427/520; 427/512

(57) ABSTRACT

The present invention is directed to a coating composition that can be cured by radiation, chemical crosslink or both radiation and chemical crosslink. The coating composition comprises one or more radiation curable unsaturated double bonds and one or more crosslinkable functional groups, wherein a layer of said coating composition applied over a substrate cures into a dry coating when exposed to actinic radiation and said dry coating has a glass transition temperature between 15° C. to 120° C. The coating composition can be used in either 1K or 2K coating systems. This invention is also directed to a method of using said coating composition to coat a substrate including a vehicle, a vehicle body or parts thereof.

### FIELD OF INVENTION

The present invention is directed to a coating composition that can be cured by radiation, chemical crosslinking or both radiation and chemical crosslinking. This invention is also directed to a method of using the radiation and chemical curable coating composition to coat a substrate.

### BACKGROUND OF INVENTION

Coatings used during the repair of damaged automotive vehicles generally include several layers of different coating compositions. An initial coating is usually a primer coating resulting from a coating composition formulated as a primer with or without a sealer. The primer coating commonly contains pigments, fillers, or a combination thereof. Over the primer coating, a topcoating is applied which itself can result from more than one type of coating compositions, such as such as basecoat and clearcoat compositions. The coatings can be cured by different curing mechanisms, such as chemical crosslinking or radiation cure preferably by ultraviolet (UV) radiation. A coating curable by UV radiation typically contains UV curable double bond such as acrylic double bond. A coating curable by chemical crosslinking typically contains crosslinkable groups, such as hydroxyl groups, and corresponding crosslinking groups, such as isocyanate groups.

A coating that can only be cured by one curing mechanism is referred to as a mono-cure coating. Conventionally, a typical mono-cure coating composition that contains one or more components having acrylic double bonds can be cured by UV radiation in which the double bonds of the acrylic groups undergo polymerization to form crosslinked network. A mono-cure coating is also known as 1K coating. U.S. Pat. No. 6,087,413, for example, discloses a mono-cure type UV curable clearcoat composition that can be completely cured by UV radiation to form a dry coating. A UV curable coating composition can usually have indefinite pot life until being sprayed and irradiated with UV light. Upon UV radiation, the UV curable coating can be cured to form a dry coating in very short period of time, typically within a few minutes. One of the disadvantages of mono-cure coating is that un-even or insufficient radiation may occur on a large coating area or in shaded areas. In the case of three-dimensional substrates of complicated geometry, for example automotive vehicle bodies, even and sufficient UV radiation is hard to achieve. To overcome that disadvantage, dual-cure coatings were developed.

A dual-cure coating is a coating that can be cured by two curing mechanisms, such as UV radiation and chemical crosslink. A dual-cure coating is also known as a 2K coating that are typically packaged in two separate containers. Typically, a dual-cure coating composition contains a first component having both radiation curable groups, such as acrylic double bonds, and chemical crosslinkable groups, such as hydroxyl, in one container. A second component contains a corresponding crosslinking agent having crosslinking groups, such as isocyanate groups and is stored in a second container. Just prior to use, the first component and the second component are mixed to form a pot mix. U.S. Pat. No. 6,815,501, for example, discloses a dual-cure type UV curable coating composition comprising double bonds and hydroxyl functional groups that can be cured by a combination of UV radiation and isocyanate crosslinking agents. A disadvantage of such dual-cure coating is that it requires both the crosslinking agent and UV radiation to form a dry coating. The use of the crosslinking agent, such as isocyanates, results in limited pot life of the pot mix losing the advantage of a UV mono-cure coating composition that can usually have indefinite pot life until being sprayed and irradiated with UV light.

### STATEMENT OF INVENTION

This invention is directed to a coating composition comprising a component A comprising one or more monomers, oligomers, or polymers having one or more radiation crosslinkable functional groups D and one or more chemical crosslinkable functional groups X, wherein a layer of said coating composition applied over a substrate cures into a dry coating when exposed to actinic radiation and said dry coating has a glass transition temperature (Tg) between 15° C. to 120° C., wherein the one or more functional groups D are radiation crosslinkable ethylenically unsaturated double bonds and the functional groups X are selected from hydroxyl, isocyanate, epoxy, acid, thioisocyanate, acetoacetoxy, carboxyl, amine, anhydride, ketimine, aldimine, urethane group, or a workable combination thereof.

This invention is also directed to a method for coating a substrate comprising the steps of:
a) providing a coating composition, wherein said coating composition is selected from:
   (i) a one-package coating composition comprising a component A comprising one or more monomers, oligomers, or polymers having one or more radiation crosslinkable functional groups D and one or more chemical crosslinkable functional groups X, wherein a layer of said one-package coating composition applied over a substrate cures into a dry coating when exposed to actinic radiation, wherein the one or more functional groups D are radiation crosslinkable ethylenically unsaturated double bonds and the functional groups X are selected from hydroxyl, isocyanate, epoxy, acid, thioisocyanate, acetoacetoxy, carboxyl, amine, anhydride, ketimine, aldimine, urethane group, or a workable combination thereof; or
   (ii) a two-package coating composition prepared by mixing a package I and a package II, wherein said package I comprises the component A, and said package II comprises:
      (1) a component B comprising one or more monomers, oligomers, or polymers having one or more functional groups Y that react with the functional groups X to form crosslink;
      (2) a component C comprising one or more monomers, oligomers, or polymers having said one or more functional groups Y and said one or more functional groups D; or
      (3) a combination of the component B and C;
      wherein said functional groups X and Y are pair wise selected from hydroxyl and isocyanate groups, epoxy and acid groups, epoxy and isocyanate groups, isocyanate and amine groups, or isocyanate and urethane groups;
b) applying the coating composition to the substrate to form a coating layer;
c) irradiating the coating layer with actinic radiation to form a dry coating on said substrate.

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

The term “radiation”, “irradiation” or “actinic radiation” means radiation that causes, in the presence of a photoinitiator, polymerization of monomers that have ethylenically unsaturated double bonds, such as acrylic or methacrylic double bonds. Sources of actinic radiation may be natural sunlight or artificial radiation sources. Examples of actinic radiation include, but not limited to, UV-A radiation, which falls within the wavelength range of from 320 nanometers (nm) to 400 nm; UV-B radiation, which is radiation having a wavelength falling in the range of from 280 nm to 320 nm; UV-C radiation, which is radiation having a wavelength falling in the range of from 100 nm to 280 nm; and UV-V radiation, which is radiation having a wavelength falling in the range of from 400 nm to 800 nm. Other examples of radiation can include electron-beam, also known as e-beam. Many artificial radiation sources emit a spectrum of radiation that contains UV radiation having wavelengths shorter than 320 nm. Actinic radiation of wavelengths shorter than 320 nm emits high energy and can cause damage to the skin and eyes. Radiations with longer wavelengths, such as UV-A or UV-V, emit lower energy and are considered safer than radiations with shorter wavelengths, such as UV-C or UV-B.

For a “two-pack coating composition”, also known as 2K coating composition, typically two components are stored in separate containers and sealed to increase the shelf life of the components of the coating composition during storage. The components are mixed just prior to use to form a pot mix, which has a limited pot life, typically ranging from a few minutes (15 minutes to 45 minutes) to a few hours (4 hours to 8 hours). The pot mix is then applied as a layer of a desired thickness on a substrate surface, such as an automobile body. After application, the layer dries and cures at ambient or at elevated temperatures to form a coating on the substrate surface having desired coating properties, such as, high gloss, mar-resistance and resistance to environmental etching.

A pot life is a time period between the time when components of a coating composition are mixed to form a pot mix, referred to as time zero, and to the time when the pot mix becomes too thick or too hard for practical application. A pot life of a specific coating composition is a characteristic of that coating composition and is typically determined empirically. Pot life can be measured, for example, by the length of time required to double viscosity of the coating composition or pot mix using Zahn cup viscosity measurements. If after 24 hours, viscosity of a coating composition is not doubled, said coating composition can be referred to as having indefinite pot life.

Typically, a mono-cure or 1K coating composition, for example a UV mono-cure coating composition, can be prepared to form a pot mix and stored in a sealed container. As long as said UV mono-cure coating composition is not exposed to UV radiation, said UV mono-cure coating composition can have indefinite pot life.

For a dual cure or 2K coating composition, two components are typically stored separately and only mixed prior to use. Once the two components are mixed, the pot mix will have limited pot life, typically a few hours.

A “coated substrate” refers to a substrate covered with a coating, or multiple coatings. A coating or coatings can be a primer, a pigmented basecoat, a topcoat, or a clearcoat. The substrate can be covered by multiple layers of two different coatings, such as one or more layers of primers and one or more layers of pigmented basecoats as topcoats. The substrate can also be covered by multiple layers of at least three different coatings, such as one or more layers of primers, one or more layers of pigmented basecoats, and one or more layers of un-colored clearcoats. Examples of coated substrates can be a vehicle body or body parts coated with one or more monocolor paints, a vehicle body or body parts coated with one or more metallic paints, a bicycle body or body parts coated with one or more paints, a boat or boat parts coated with one or more paints, furniture or furniture parts coated with one or more paints, an airplane coated with one or more paints. The substrate can be made of metal, wood, plastic or other natural or synthetic materials.

As used herein “vehicle” includes an automobile, such as car, bus, truck, semi truck, pickup truck, SUV (Sports Utility Vehicle); tractor; motorcycle; trailer; ATV (all terrain vehicle); heavy duty mover, such as, bulldozer, mobile crane and earth mover; airplanes; boats; ships; and other modes of transport that are coated with coating compositions.

“Crosslinkable functional groups” are functional groups positioned in each molecule of compounds, oligomer, polymer, the backbone of the polymer, pendant from the backbone of the polymer, terminally positioned on the backbone of the polymer, or a combination thereof, wherein these functional groups are capable of crosslinking with the crosslinking functional groups (during the curing step) to produce a coating in the form of crosslinked structures. One of ordinary skill in the art would recognize that certain crosslinkable functional group combinations would be excluded, since, if present, these combinations would crosslink among themselves (self-crosslink), thereby destroying their ability to crosslink with the crosslinking functional groups defined below. A workable combination of crosslinkable functional groups refers to the combinations of crosslinkable functional groups that can be used in coating applications excluding those combinations that would self-crosslink.

Typical crosslinkable functional groups can be selected from hydroxyl, thiol, isocyanate, thioisocyanate, acid or polyacid, acetoacetoxy, carboxyl, primary amine, secondary amine, epoxy, anhydride, ketimine, aldimine, or a combination thereof. Some other functional groups such as orthoester, orther carbonate, or cyclic amide that can generate hydroxyl or amine groups once the ring structure is opened, can also be suitable as crosslinkable functional groups.

“Crosslinking functional groups” are functional groups positioned in each molecule of monomer, oligomer, polymer, the backbone of the polymer, pendant from the backbone of the polymer, terminally positioned on the backbone of the polymer, or a combination thereof, wherein these functional groups are capable of crosslinking with the crosslinkable functional groups (during the curing step) to produce a coating in the form of crosslinked structures. One of ordinary skill in the art would recognize that certain crosslinking group/crosslinkable functional group combinations would be excluded from the present invention, since they would fail to crosslink and produce the film forming crosslinked structures.

Typical crosslinking functional groups can be selected from the group consisting of hydroxyl, thiol, isocyanate, thioisocyanate, acid or polyacid, acetoacetoxy, carboxyl, primary amine, secondary amine, epoxy, anhydride, ketimine, aldimine, orthoester, orthocarbonate, cyclic amide or a combination thereof. One of ordinary skill in the art would recognize that certain crosslinking functional group combinations would be excluded, since, if present, these combinations would crosslink among themselves (self-crosslink), thereby destroying their ability to crosslink with the crosslinkable functional groups. A workable combination of crosslinking functional groups refers to the combinations of crosslinking functional groups that can be used in coating applications.

It would be clear to one of ordinary skill in the art that certain crosslinking functional groups crosslink with certain crosslinkable functional groups. Examples of paired combinations of crosslinkable and crosslinking functional groups include: (1) ketimine crosslinking functional groups generally crosslink with acetoacetoxy, epoxy, or anhydride crosslinkable functional groups; (2) isocyanate, thioisocyanate and melamine crosslinking functional groups generally crosslink with hydroxyl, thiol, primary and secondary amine, ketimine, or aldimine crosslinkable functional groups; (3) epoxy crosslinking functional groups generally crosslink with carboxyl, primary and secondary amine, ketimine, or anhydride crosslinkable functional groups; (4) amine crosslinking functional groups generally crosslink with acetoacetoxy crosslinkable functional groups; (5) polyacid crosslinking functional groups generally crosslink with epoxy or isocyanate crosslinkable functional groups; (6) anhydride crosslinking functional groups generally crosslink with epoxy and ketimine crosslinkable functional groups; and (7) isocyanate crosslinking functional groups react with urethane crosslinkable functional groups to form allophanate.

Isocyanate functional groups can be present in polyisocyanates or oligomers, wherein said polyisocyanates or oligomers can have multiple isocyanate crosslinking functional groups, also known as crosslinking isocyanate functionalities. Typically, the polyisocyanates are provided within the range of 1 to 10, preferably 1 to 8, more preferably 2 to 5 isocyanate crosslinking functional groups. Some suitable polyisocyanates include aromatic, aliphatic, or cycloaliphatic polyisocyanates, trifunctional polyisocyanates and isocyanate functional adducts of a polyol and difunctional isocyanates. Some of the particular polyisocyanates include diisocyanates, such as 1,6-hexamethylene diisocyanate, isophorone diisocyanate, 4,4′-biphenylene diisocyanate, toluene diisocyanate, biscyclohexyl diisocyanate, tetramethyl-m-xylylene diisocyanate, ethyl ethylene diisocyanate, 1-methyltrimethylene diisocyanate, 1,3-phenylene diisocyanate, 1,5-napthalene diisocyanate, bis-(4-isocyanatocyclohexyl)-methane and 4,4′-diisocyanatodiphenyl ether.

Some of the suitable trifunctional polyisocyanates include triphenylmethane triisocyanate, 1,3,5-benzene triisocyanate, and 2,4,6-toluene triisocyanate. Trimers of diisocyanate, such as the trimer of hexamethylene diisocyanate sold under the trademark Desmodur® N3300A Polyisocyanate by Bayer Material Science LLC, of Pittsburgh, Pa., trimers of isophorone diisocyanate, both symmetric and asymmetric trimers, are also suitable. Furthermore, trifunctional adducts of triols and diisocyanates are also suitable. Trimers of diisocyanates are preferred and trimers of isophorone and hexamethylene diisocyanates are more preferred.

One or more photoinitiators and/or sensitizers that cause photopolymerization upon radiation can be included in an amount sufficient to obtain the desired cure response. Typically, the one or more photoinitiators are included in amounts of about 1% to about 15% by weight of the solid weight of a coating composition. As known to those skilled in the art, many photoinitiators can be suitable for the invention. These include, but not limited to, benzophenone, benzion, benzionmethyl ether, benzion-n-butyl ether, benzion-iso-butyl ether, propiophenone, acetophenone, methyphenylgloxylate, 1-hydroxycyclohexyl phenyl ketone, 2, 2-diethoxyacetophenone, ethylphenylpyloxylate, diphenyl (2,4,6-trimethylbenzoyl)-phosphine oxide, phosphine oxide, phenyl bis (2,4,6-trimethyl benzoyl), phenanthraquinone, and a combination thereof. Other commercial photoinitiator products, or a combination thereof, such as Darocure® 1173, Darocure® MBF, Darocure® TPO or Irgacure® 184, Irgacure® 4265, Irgacure® 819, Irgacure® 2022 or Irgacure® 2100 from Ciba Co., are also suitable. Darocure® and Irgacure® are registered trademarks of Ciba Specialty Chemicals Corporation, New York.

A coating composition of this invention can optionally include a suitable inert solvent. Representatives of such solvents include ester solvents, e.g. ethyl acetate, or butyl acetate; ketone solvents, e.g. acetone, methylisobutylketone, or methylethylketone; alcohols, such as butyl alcohol; aromatic solvents, such as toluene or xylene; and ether solvent. Other solvent such as tert butylacetate, Oₓₛₒl® 100 (Oxsol® is a registered trademark of OCCIDENTAL CHEMICAL CORPORATION, NEW YORK), acetone, methylacetate, or a combination can also be used to reduce VOC (volatile organic compounds) level of the coating composition. The amount of solvent included in the coating composition will vary in accordance with the particular application at hand. For instance, for spray applications, higher levels of solvent will typically be included, while for roll applications, lower levels of inert solvent, if any, will be employed.

Additives such as light stabilizers, e.g. suitable hindered amines and/or benzotriazole derivatives, such as TINUVIN® from Ciba can be used. Other additives, such as low molecular weight polyacrylic for flow and leveling; polymeric silicone coating surface improvers; dyes; pigments; antioxidants; or flatting agents, such as wax-coated or non-wax-coated silica or other inorganic materials; can also be used. Commercially available flow additives, such as BYK® 301, BYK® 306, BYK® 331, BYK® 333, BYK® 325, BYK® 358, or BYK® 352 available from BYK-CHEMIE, Wallingford, Conn., can be included. BYK® is a registered trademark of BYK-CHEMIE, Wallingford, Conn.

The phrase “dry-to-touch” or “dry coating” means when the surface of a cured coating is touched with an object such as, a dry finger, gauze, or cotton swab, no visible marks appear on the surface. A “sticky” coating means the surface of that coating is not dry-to-touch and a mark is left on the coating when touched.

The phrase “tacky” means when the surface of a cured coating is touched with an object such as, a dry finger, gauze, or cotton swab, visible marks appear on the surface. The tacky layer may be fluid enough to flow and consequently heal, such that any visible marks on the surface of the tacky layer are no longer visible. Tackiness can be the consequence of a layer that has not fully cured and is thus not preferred in the refinish applications. Therefore, tacky material from the surface of a coating needs to be further cured or removed prior to sanding said coating layer or prior to applying subsequent coating layers over the tacky coating layer.

This invention is directed to a coating composition that can be cured to form a dry coating by UV radiation, chemical crosslink, or both the UV radiation and the chemical crosslink, said dry coating has a glass transition temperature (Tg) between 15° C. and 120° C., preferably between 25° C. and 100° C. The coating composition comprises a component A comprising one or more monomers, oligomers, or polymers having one or more radiation crosslinkable functional group D and one or more chemical crosslinkable functional group X.

The radiation crosslinkable functional group D, hereafter referred to as the group D, can be ethylenically unsaturated double bonds of monomers, oligomers or polymers that can undergo polymerization upon radiation. Examples of said monomers, oligomers, or polymers can include, but not limited to, α,β-unsaturated carboxylic acid derivatives such as acrylic, methacrylic, acrylates, methacrylates, maleates, fumarates, maleimides, acrylamides, methacrylamide and oligomers or polymers derived from said α,β-unsaturated carboxylic acid derivatives.

The chemical crosslinkable functional group X, hereafter referred to as the group X, can be any of the aforementioned crosslinking or crosslinkable functional groups.

It is known that the group D, such as acrylic double bonds, and the group X, such as hydroxyl groups are present in some currently available commercial coating products. Examples of such commercial products include hydroxyl-bearing polyester Desmophen VP LS-2089 which has the group D (acrylic double bond) and one form of the group X (hydroxyl group), and Isocyanate-bearing urethane acrylate Desmolux VP LS-2337 which has the group D (acrylic double bond) and another form of the group X (isocyanate group). However, these commercial products, such as Desmophen VP LS 2089, available from Bayer Material Science, Pittsburgh, Pa., USA, designed for dual-cure coating compositions, fails to form a dry coating under UV radiation alone.

Applicant of this patent application unexpectedly discovered that by adding additional components to those commercial products designed for dual-cure coating compositions to modify the Tg of the resulting coating, a dry coating can be cured by UV radiation alone while maintaining the ability for dual cure. In one example, additional components comprising monomers, oligomers, or polymers having ethylenically unsaturated double bonds, such as a mixture of unsaturated aliphatic urethane acrylates, can be added to Desmorphen VP LS 2089 and the resulted coating composition forms a dry coating upon UV radiation. Commercial available mixture of unsaturated aliphatic urethane acrylates, such as Desmolux VP LS 2308, or its variations, such as LS-2308-NO HDDA (Hexanedioldiacrylate), all available from Bayer, can be suitable for this invention.

Such results are unexpected by those skilled in the art: it is traditionally understood that in order to cure a coating comprising monomers, oligomers, or polymers having UV curable double bonds and hydroxyl groups, such as the hydroxyl-bearing polyester Desmophen VP LS-2089, a crosslinking agent, such as isocyanates, must be used.

One advantage of the coating composition of this invention is that the coating composition can have indefinite pot life as long as it is not exposed to actinic radiation, such as UV radiation, during storage while maintaining the ability to form a dry coating upon radiation alone. Another advantage is that the coatings of this invention can form dry coating film within 60 minutes, typically within 5-35 minutes after UV or other actinic radiation.

The coating composition of this invention can further comprise components selected from: (i) a component B comprising one or more monomers, oligomers, or polymers having one or more functional groups Y that react with the group X to form crosslink; (ii) a component C comprising one or more monomers, oligomers, or polymers having said one or more functional group Y and one or more said functional groups D; or (iii) a combination thereof.

Although the coating composition of this invention can be cured by actinic radiation alone to form a dry coating, it is desired that the coating composition can also be cured by chemical crosslink or both radiation and chemical crosslink. Such coating composition can be useful for large areas that even radiation is often difficult to achieve in a cost effective and timely fashion, or for shaded coating areas that UV radiation cannot reach.

The functional group Y, hereafter referred to as the group Y, in the component B or C can react with the group X in the component A to form crosslinked structures resulting in a dry coating. The group Y can be selected from any of the aforementioned crosslinking or crosslinkable groups. It is understood that those skilled in the art can select pairs of the group X and the group Y to form desired crosslinked structures. For example, if the group X is a hydroxyl group or a thiol group, then the group Y should be selected from isocyanate groups, epoxy groups, or other hydroxyl or thiol reacting groups. In one example, the group X can be an isocyanate group while the group Y can be a hydroxyl or thiol group. In another example, the group Y can be an isocyanate group while the group X can be a hydroxyl or thiol group. Some of additional paired combinations include, but not limited to: (1) ketimine groups generally crosslinking with acetoacetoxy, epoxy, or anhydride groups; (2) isocyanate and melamine groups generally crosslinking with hydroxyl, thiol, primary and secondary amine, ketimine, or aldimine groups; (3) epoxy groups generally crosslinking with hydroxyl, carboxyl, primary and secondary amine, ketimine, or anhydride groups; (4) amine groups generally crosslinking with acetoacetoxy or isocyanate or epoxy groups; (5) acid or polyacid groups generally crosslinking with epoxy groups; and (6) anhydride groups generally crosslinking with epoxy or amine and ketimine groups.

The coating composition of this invention can comprise one or more aforementioned photoinitiators.

The coating composition of this invention can further comprise one or more catalysts for the reaction between the group X and Y, one or more rheology control agents, one or more pigments, UV protection package, flow additives, or a combination thereof, as known to those skilled in the art, to produce coatings with desired properties such as gloss, hardness, or color.

The coating composition of this invention can be supplied in two separate containers.

In one example, a first container contains the component A comprising materials having acrylic double bonds as the group D and hydroxyl groups as the group X, one or more photoinitiators, solvents, rheology control agents, one or more pigments, UV protection package, flow additives and other additives. A second container contains the component B comprising polyisocyanates comprising isocyanate groups as the group Y with or without catalyst such as dibutyltindilaurate (DBTDL).

In another example, a first container contains the component A comprising materials having acrylic double bonds as the group D and isocyanate groups as the group X, one or more photoinitiators, solvents, rheology control agents, one or more pigments, UV protection package, flow additives and other additives. A second container contains the component B comprising polymer comprising hydroxyl groups as the group Y and optional acrylic double bonds as the group D and optionally the aforementioned catalyst dibutyltindilaurate (DBTDL).

In yet another example, a first container contains the component A comprising acrylic double bonds as the group D and hydroxyl groups as the group X, one or more photoinitiators, solvents, rheology control agents, one or more pigments, UV protection package, flow additives and other additives. A second container comprises isocyanate-bearing aliphatic urethane acrylate comprising isocyanate groups as the group Y and acrylic double bonds as the group D and optionally the aforementioned catalyst dibutyltindilaurate (DBTDL).

One advantage of this invention is that when an area of a substrate expected to be coated with the coating composition can be readily irradiated with even radiation in a short period of time, such as a few minutes of UV lamp radiation, a coating technician can choose to only use a portion of the component A from the first container. The rest of the component A can be kept in the first container for later use without being wasted since the component A can have indefinite pot life if not exposed to UV radiation. When a large area of a substrate is expected to be coated, or some parts of the substrate are shaded and not reachable by a UV lamp radiation, the coating technician can choose to add component B or C from the second container so the entire coated area can be cured to form a dry coating with or optionally without the UV irradiation. The coating composition of this invention provides flexibility for coating a substrate in various situations without the need to test a different coating composition. Traditional mono-cure and dual-cure coating compositions lack such flexibility.

The coating composition of this invention can be formulated for the use as a clearcoat, a topcoat, a primer, a sealer, or a basecoat.

This invention is also directed to a method for coating a substrate. In one embodiment, said method comprises the following steps.

In step a), a coating composition is selected. The coating composition can be selected from: (i) a one-package (1K) coating composition or (ii) a two-package (2K) coating composition.

The 1K coating composition can comprise a component A comprising one or more monomers, oligomers, or polymers having one or more actinic radiation crosslinkable functional groups D and one or more chemical crosslinkable functional groups X, wherein a layer of said coating composition applied over a substrate cures into a dry coating when exposed to actinic radiation and said dry coating has a glass transition temperature (Tg) between 15° C. to 120° C., wherein the one or more functional groups D are actinic radiation crosslinkable ethylenically unsaturated double bonds and the functional groups X are selected from hydroxyl, isocyanate, epoxy, acid, thioisocyanate, acetoacetoxy, carboxyl, amine, anhydride, ketimine, aldimine, urethane group, or a workable combination thereof.

The two-package (2K) coating composition can comprise a package I and a package II, wherein said package I comprises the aforementioned component A, and said package II comprises a component B, a component C or a combination of the component B and C.

Said component B in the package II can comprise one or more monomers, oligomers, or polymers having one or more functional groups Y that react with the functional groups X to form crosslink. Said component C can comprise one or more monomers, oligomers, or polymers having said one or more functional groups Y and said one or more functional groups D.

Said functional groups X and Y can be pairwise selected from hydroxyl and isocyanate groups, epoxy and acid groups, epoxy and isocyanate groups, isocyanate and amine groups, isocyanate and urethane groups, or other aforementioned paired combinations of the crosslinking and crosslinkable functional groups.

This invention provided an advantage to use the same component A in both 1K or 2K coating compositions. When the substrate to be coated is of small size and simple geometry that can be radiated with a UV lamp evenly in short period of time, a 1K coating composition that has only the component A can be selected and applied to the substrate. When the substrate to be coating is of large size or in complex geometry so it cannot be easily radiated with a UV lamp or requires extended period of UV exposure, then a 2K coating composition can be selected. Such 2K coating composition can have a package I comprises the component A and a package II that comprises the component B, the component C, or a combination of the component B and C. The package I and the package II can be formulated so that certain volumes of the package I and II can be easily mixed. In one example, four volumes of the package I and one volume of the package II can be mixed to form the 2K coating composition. The package I and II can be mixed in a container just before spraying coating application.

In step b), the selected coating composition can be applied to the substrate to form a coating layer. Conventional coating application techniques known to those skilled in the art, such as spraying, brushing, dipping, or rolling can be suited for this invention.

In step c), the coating layer is irradiated with actinic radiation to form a dry coating on said substrate. For example, UV radiation can be provided with a UV lamp or a UV flash lamp. The UV radiation can be provided at a specific wavelength or a range of wavelengths, such as UV-A, UV-B, UV-C, UV-V or a mixture thereof. UV radiation can also be provided for specific time duration, such as in a range of from a few seconds to a few minutes; or at specific intensity and power to cause curing of the coating composition. Those skilled in the art can select specific UV lamp or UV filters to produce desired UV radiations. For example, a high pressure mercury lamp can be suitable for this invention. If desired, temperature can also be modified by those skilled in the art.

The method of this invention can have an optional step d) to further cure the coating layer at ambient temperatures, such as the temperatures that are generally considered as room temperatures such as from about 18° C. to about 23° C., if a two-package (2K) coating composition is selected.

Another advantage of this invention is that the package II can be mixed with the package I in an “on-demand” fashion during spraying application. In one example, both the package I and the package II can be supplied to a spray gun through separate controls, such as individual containers, tubes, valves or switches. The controls can be configured so the package I can be continuously sprayed onto the substrate to form a coating layer and the package II can be mixed with the package I when so desired. For example, when spray coating a mirror casing of a vehicle, a painter can use the package I for most of the casing surface that can be readily exposed to UV light. For parts of the casing surface that are in shaded areas not readily exposed to UV light, the painter can open the control to allow the package II being mixed with the package I. The coating layer in the shaded areas, formed by the mixed package I and II, can be readily cured through crosslink reaction between the crosslinkable and the crosslinking groups in the coating composition even with limited or optionally without UV radiation.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

Hardness measurement is performed by using either Persoz machine available by a GARDCO® Pendulum Hardness Tester Model HA-5854 manufactured by BYK Chemie, Germany and sold by Paul N. Gardness Company, Inc. Pompano Beach, Fla.; or FISCHERSCOPE® machine from Helmut FISCHER Co. GMBH; 7032 Sudelfingen, Germany. Persoz hardness is used when expected hardness value is between 0 and 250 seconds. FISCHERSCOPE® machine is used when expected Persoz hardness value could be beyond 200 seconds. The measurement from the FISCHERSCOPE® is in Newtons per square millimeter (N/mm²). The higher the hardness value, the harder is the coating film. FISCHERSCOPE® is a registered trademark of Helmut Fischer GmbH & Co., Sindelfingen, GERMANY.

Swell ratio was determined by measuring diameters of a cut circle of a coating film, before and after adding methylene chloride. The diameter of the unswollen coating film (D₀) was measured using a microscope with a 10× magnification and a filar lens. Four drops of methylene chloride were added to the coating film and the film was allowed to swell for a few seconds and then a glass slide was placed over the film and the swollen film diameter (Dₛ) was measured. The swell ratio was then calculated as follow: Swell Ratio=(Dₛ)²/(Dₒ)².

Gel fraction was measured according to the procedure set forth in U.S. Pat. No. 6,221,494 col. 8 line 56 to col. 9 line 2 which procedure is hereby incorporated by reference.

Pot life in following examples is define by the length of time required to double viscosity of the coating composition or the relevant pot mix and was determined using Zahn cup #2 viscosity measurements in second. If after 24 hours, viscosity of a coating composition is not more than 50% of its original viscosity at the time of mixing, said coating composition is referred to as having indefinite pot life.

All ingredients are in grams. All percentages are weight percentage unless specified otherwise.

### Comparative Examples 1-5

Comparative coating compositions (Comp Ex 1 through Comp Ex 5) were prepared according to Table 1. The resulted coating pot mixes were spray coated onto test panels. The coated test panels were exposed to UV radiation with a UV light, available from H&S Autoshot, Georgetown, ON, Canada, for 3 to 6 minutes, to form coatings.

Properties of the coatings were examined and shown in Table 1. All properties were measured under ambient (about 75° F.) temperature.

Comparative Example 1 used only one isocyanate-bearing urethane acrylate resin DESMOLUX VP-LS-2337 containing UV curable double bonds and isocyanate (NCO) crosslinking groups while Comparative Example 2 used only one hydroxyl-bearing polyester resin DESMOPHEN VP LS-2089 containing UV curable double bonds and hydroxyl crosslinkable groups.

Results showed that in the Comparative Example 1, after 3 minutes UV light exposure, the coating was not cured and was sticky. The coating of Comparative Example 1 remained sticky even after 24 hrs. The same result was seen with the Comparative Example 2, except that it was less sticky after 24 hrs but still finger printing. Due to the lack of coating film integrity, gel fraction assay was not possible to perform for the Comparative Examples 1 and 2.

Comparative Examples 3, 4 and 5 included various combinations of hydroxyl-bearing polyester DESMOPHEN VP LS-2089 and isocyanate group containing acrylate DESMOLUX VP LS-2337. The curing continues to beyond 24 hours. Data on hardness, swell ratio and gel fraction indicated more coating film formation with time than that of the Comparative Example 1 and 2. However, coating film formation required long time, such as over 24 hrs.

Tg data is not available for the Comparative Example 1 due the fact that the coating film was too soft and fragile to determine its Tg after curing for about 24 hours. For the Comparative Examples 2-5, Tg data can be determined at 24 hours of curing or at one week of curing. The Tg data at 24 hours and at one week curing were the same for each example.

TABLE 1
Coating Composition and Property

| | Comp | Comp | Comp | Comp | Comp |
|---|---|---|---|---|---|
| | Ex 1 | Ex 2 | Ex 3 | Ex 4 | Ex 5 |
| Hydroxyl-bearing | 0 | 66.67 | 21.18 | 25.14 | 30.92 |
| polyester | | | | | |
| DESMOPHEN VP | | | | | |
| LS-2089 (75% | | | | | |
| Solid) | | | | | |
| Isocyanate-bearing | 50 | 0.00 | 34.11 | 31.15 | 26.81 |
| urethane acrylate | | | | | |
| Desmolux VP LS- | | | | | |
| 2337 (100% Solids) | | | | | |
| Photoinitiator | 0.43 | 0.41 | 0.43 | 0.42 | 0.44 |
| Irgacure ® 184 | | | | | |
| Photoinitiator | 1.27 | 1.24 | 1.29 | 1.27 | 1.31 |
| Darocur ® TPO | | | | | |
| Photoinitiator | 0.43 | 0.41 | 0.43 | 0.42 | 0.44 |
| Darocur ® MBF | | | | | |
| MethylEthyl Ketone | 47.87 | 31.27 | 42.55 | 41.60 | 40.08 |
| TOTAL solids and | 100 | 100 | 100 | 100 | 100 |
| solvents (%) | | | | | |
| Ready to spray | 50 | 50 | 50 | 50 | 50 |
| SOLIDS (%) | | | | | |
| PERCENT | 0 | 100 | 32 | 38 | 46 |
| DESMOPHEN VP | | | | | |
| LS-2089 | | | | | |
| PERCENT | 100 | 0 | 68 | 62 | 54 |
| isocyanate-bearing | | | | | |
| urethane acrylate | | | | | |
| DESMOLUX VP | | | | | |
| LS-2337 | | | | | |
| TIME UNDER UVA- | 3 min | 3 min | 3 min | 3 min | 3 min |
| light (min) | | | | | |
| Hardness, Persoz | n/a | n/a | n/a | n/a | n/a |
| same day (at 30 | (Sticky) | (Sticky) | (Sticky) | (Sticky) | (Sticky) |
| min) | | | | | |
| Hardness, Persoz | n/a | n/a | 34 | 48 | 50 |
| same day in sec (at | (Sticky) | (Sticky) | | | |
| 2 hours) | | | | | |
| Hardness, Persoz | n/a | n/a | 117 | 133 | 116 |
| (sec) at 24 hrs | (Sticky) | (Sticky) | | | |
| Hardness, | n/a | n/a | 37 | 40 | 43 |
| Fischerscope | (Sticky) | (Sticky) | | | |
| hardness (N/mm²) | | | | | |
| at 24 hrs | | | | | |
| Swells ratio at 24 | n/a | 1.65 | 1.36 | 1.35 | 1.29 |
| hrs | (Sticky) | | | | |
| Gel Fractions (%) at | n/a | n/a | 85.2 | 86.8 | 86.4 |
| 3 hrs | (Sticky) | (Sticky) | | | |
| Gel Fractions (%) (1 | n/a | n/a | 90.6 | 91.4 | 91.4 |
| day) | (Sticky) | (Sticky) | | | |
| Tg (° C.) | n/a | −10 | 54 | 49 | 26 |

Note:
Hydroxyl-bearing polyester Desmophen VP LS-2089 (75% Solid) and Isocyanate-bearing urethane acrylate Desmolux VP LS-2337 (100% Solids) are available from Bayer Material Science, Pittsburgh, Pennsylvania, USA.
Photoinitiators Irgacure ® 184, Darocur ® TPO, and Darocur ® MBF are available from Ciba Specialty Chemicals, Tarrytown, New York, USA, under respective registered trademarks.

### Examples 1-3

Coating compositions of Example 1, 2 and 3 were prepared according to Table 2.

Example 1 showed that by adding unsaturated acrylic monomer DESMOLUX VP-LS-2308 which has only double bond, to the isocyanate-bearing urethane acrylate DESMOLUX VP LS-2337 which has double bond and crosslinking isocyanate groups, a dry coating formed upon UV-A exposure for 3 minutes. Hardness of the coating of this example was increased from 43 at 5 minutes to 179 at 24 hrs. There was no corresponding crosslinkable functional group in this example (Table 3).

Example 2 showed that by adding unsaturated aliphatic urethane acrylate DESMOLUX VP-LS-2308 which has only double bond groups to hydroxyl-bearing polyester DESMOPHEN VP LS-2089 which has double bond and Hydroxyl crosslinkable groups, a dry coating was formed upon UV exposure. Hardness of the coating of this example was increased from 23 at 5 minutes to 86 at 24 hrs. There was no corresponding crosslinking functional group in this example (Table 3).

Example 3 showed that by adding the unsaturated aliphatic urethane acrylate DESMOLUX VP-LS-2308 to the mixture of hydroxyl-bearing polyester DESMOPHEN VP LS-2089 and DESMOLUX VP LS-2337, a dry coating was formed upon exposure to UVA for 3 minutes. The coating had similar hardness as that of Example 1 (Table 3). There were both crosslinking isocyanate group from DESMOLUX VP LS-2337, and corresponding crosslinkable hydroxyl functional group from DESMOLUX VP LS-2308, in this example.

The coatings of the Example 1-3 formed dry film within 60 minutes, typically within 5-5 minutes after UV radiation as indicated by the hardness data in Table 3.

TABLE 2
Coating Composition

| | Ex 1 | Ex 2 | Ex 3 |
|---|---|---|---|
| Hydroxyl-bearing polyester | 0 | 24.00 | 15.53 |
| DESMOPHEN VP LS-2089 | | | |
| Isocyanate-bearing urethane | 24.80 | 0 | 19.50 |
| acrylate DESMOLUX VP LS-2337 | | | |
| Unsaturated aliphatic urethane | 25.20 | 0 | 18.85 |
| acrylate DESMOLUX VP-LS-2308 | | | |
| (80% solid in 20% HDDA) | | | |
| Unsaturated aliphatic urethane | 0 | 40 | 0 |
| acrylate Desmolux VP LS 2308-NO | | | |
| HDDA (80% Solids in 20% | | | |
| ButylAcetate) | | | |
| Photoinitiator Irgacure ® 184 | 0.27 | 0.27 | 0.28 |
| Photoinitiator Darocur ® TPO | 0.82 | 0.82 | 0.84 |
| Photoinitiator Darocur ® MBF | 0.27 | 0.27 | 0.28 |
| METHYLETHYLKETONE | 47.24 | 33.24 | 43.32 |
| Light stabilizer TINUVIN ® 384 | 0.50 | 0.50 | 0.50 |
| Light stabilizer TINUVIN ® 292 | 0.50 | 0.50 | 0.50 |
| Flow additive BYK ®-358 | 0.40 | 0.40 | 0.40 |
| Total solids, solvents and additives | 100 | 100 | 100 |
| (%) | | | |
| READY TO SPRAY SOLIDS (%) | 50 | 50 | 50 |
| PERCENT of hydroxyl-bearing | 0 | 36 | 23.3 |
| polyester DESMOPHEN VP | | | |
| LS-2089 Solids | | | |
| PERCENT of isocyanate-bearing | 50 | 0 | 39 |
| urethane acrylate DESMOLUX VP | | | |
| LS-2337 Solids | | | |
| PERCENT of LS-2308 Solids | 40 | 64 | 30.2 |
| PERCENT of HDDA Solids | 10 | 0 | 7.5 |

Note:
Light stabilizers TINUVIN ® 384 and TINUVIN ® 292 are available from Ciba Specialty Chemicals, Tarrytown, NY. TINUVIN ® is registered trademark of Ciba CORPORATION.
Flow additive BYK ®-358 is available from BYK-Chemie, Wesel, Germany. BYK ® is a registered trademark of BYK-Chemie, Wesel, Germany.

TABLE 3
Coating Property

| | Ex 1 | Ex 2 | Ex 3 |
|---|---|---|---|
| UV Curing Time (72° F./47%) | 3 min | 3 min | 3 min |
| INITIAL VISCOSITY (SEC) | 13.3 | 16.2 | 13.9 |
| VISCOSITY (sec) -24 HRS | 13.7 | 16.9 | 13.6 |
| Hardness, Persoz (SEC) (5 mins) | 43 | 23 | 43 |
| Hardness, Persoz - (SEC) (2 | 65 | 30 | 49 |
| Hours) | | | |
| Hardness, Persoz (SEC) (5 Hours) | 80 | 40 | 74 |
| Hardness, Persoz (SEC) (24 hrs) | 179 | 86 | 155 |
| Hardness, Fischerscope (N/mm²) | 105 | 39 | 103 |
| 24 HRS | | | |
| Hardness,, Fischerscope (N/mm²) | 138 | 43 | 138 |
| 48 HRS | | | |
| Gel fraction- same day (%) | 80.0 | 77.9 | 82.4 |
| Gel fraction- next-day (%) | 87.0 | 79.9 | 89.2 |
| Tg (° C.) | 67.8 | 90 | 49.4 |

### Examples 4-6

Three different one-package (1K) coating systems (examples 4, 5 and 6) were prepared according to Table 4. Desmolux XP-2513 is an unsaturated aliphatic urethane acrylate having acrylic double bonds. Desmolux XP-2654 is an unsaturated aliphatic urethane acrylate having acrylic double bonds supplied at 60% solids in n-butyl acetate. Each 1K coating system was applied to testing panels and exposed to two sets of UV conditions: short (1 minute, Ex 4, Ex 5, and Ex 6) and long (3 minutes, Ex 4A, Ex 5A, and Ex 6A) UV-A exposure. Coating properties are shown in Table 5. Example 4, 5 and 6 showed that the hardness was lower for shorter exposure and remains about the same even after 6 days. Examples 4A, 5A and 6A showed that longer time UV-A exposure, such as 3 minutes, hardness of the coating was improved.

In these 1K coating systems, although there were crosslinkable hydroxyl groups from DESMOPHEN VP LS-2089, there were no corresponding crosslinking functional groups such as isocyanates. The coating system, after applied to test panels, formed a dry coating upon exposure to UV.

TABLE 4
1K Coating System

| | Ex 4 | Ex 4A | Ex 5 | Ex 5A | Ex 6 | Ex 6A |
|---|---|---|---|---|---|---|
| Unsaturated | 28.13 | 28.13 | 28.13 | 28.13 | 12.50 | 12.50 |
| aliphatic urethane | | | | | | |
| acrylate Desmolux | | | | | | |
| XP-2513 (100% | | | | | | |
| SOLIDS) | | | | | | |
| Unsaturated | 10.00 | 10.00 | 10.00 | 10.00 | 25.00 | 25.00 |
| aliphatic urethane | | | | | | |
| acrylate Desmolux | | | | | | |
| VP LS 2308 (80% | | | | | | |
| solid in 20% HDDA) | | | | | | |
| Unsaturated | 16.67 | 16.67 | 16.67 | 16.67 | 22.50 | 22.50 |
| aliphatic urethane | | | | | | |
| acrylate Desmolux | | | | | | |
| XP-2654 (60% solid | | | | | | |
| in 40% Butyl | | | | | | |
| Acetate) | | | | | | |
| Hydroxyl-bearing | 10.00 | 10.00 | 10.00 | 10.00 | 2.00 | 2.00 |
| polyester | | | | | | |
| Desmophen VP LS- | | | | | | |
| 2089 (75% solids) | | | | | | |
| Photoinitiator | 1.50 | 1.50 | 3.00 | 3.00 | 2.10 | 2.10 |
| Irgacure ® 184 | | | | | | |
| Photoinitiator | 1.50 | 1.50 | 0 | 0 | 0.75 | 0.75 |
| Darocur ® 1173 | | | | | | |
| Photoinitiator | 0 | 0 | 0 | 0 | 0.15 | 0.15 |
| Darocur ® TPO | | | | | | |
| Light stabilizer | 0.25 | 0.25 | 0.25 | 0.25 | 0.25 | 0.25 |
| TINUVIN ® 384 | | | | | | |
| Light stabilizer | 0.25 | 0.25 | 0.25 | 0.25 | 0.25 | 0.25 |
| TINUVIN ® 292 | | | | | | |
| Flow additive | 0.25 | 0.25 | 0.25 | 0.25 | 0.25 | 0.25 |
| BYK ®-333 | | | | | | |
| Buttyl acetate | 31.46 | 31.46 | 31.46 | 31.46 | 34.25 | 34.25 |
| Subtotal solids and | 100 | 100 | 100 | 100 | 100 | 100 |
| solvent and | | | | | | |
| additives | | | | | | |

Note:
Unsaturated aliphatic urethane acrylates Desmolux XP-2513 and Desmolux XP-2654 are available from Bayer Material Science, Pittsburgh, Pennsylvania, USA.

TABLE 5
Coating Property

| | Ex 4 | Ex 4A | Ex 5 | Ex 5A | Ex 6 | Ex 6A |
|---|---|---|---|---|---|---|
| READY TO SPRAY | 50 | 50 | 50 | 50 | 50 | 50 |
| SOLIDS | | | | | | |
| PERCENT - | 45 | 45 | 45 | 45 | 20 | 20 |
| Desmolux XP 2513- | | | | | | |
| SOLIDS | | | | | | |
| PERCENT VP LS- | 16 | 16 | 16 | 16 | 40 | 40 |
| 2308-SOLIDS | | | | | | |
| PERCENT XP-2654 | 20 | 20 | 20 | 20 | 27 | 27 |
| SOLIDS | | | | | | |
| PERCENT | 15 | 15 | 15 | 15 | 3 | 3 |
| hydroxyl-bearing | | | | | | |
| polyester | | | | | | |
| DESMOPHEN VP | | | | | | |
| LS-2089 SOLIDS | | | | | | |
| PERCENT HDDA | 4 | 4 | 4 | 4 | 10 | 10 |
| SOLIDS | | | | | | |
| UVA EXPOSURE | 1 MIN | 3 MIN | 1 MIN | 3 MIN | 1 MIN | 3 MIN |
| TIME | | | | | | |
| Hardness, | 18 | 46 | 17 | 48 | 27 | 68 |
| FISCHER- | | | | | | |
| Hardness at 24 hrs | | | | | | |
| (N/mm²) | | | | | | |
| Hardness, | 19 | 36 | 19 | 36 | 29 | 64 |
| FISCHER- | | | | | | |
| Hardness 6-days | | | | | | |
| (N/mm²) | | | | | | |
| Tg (° C.) | 31 | 52 | 21 | 56 | n/a | n/a |

### Examples 7-9

The 1K coating systems from Examples 4-6 were easily converted to two-package (2K) coating systems by mixing with a package II comprising crosslinking functional groups, such as isocyanates. The 2K systems were prepared according to Table 6. Package I of the 2K coating systems in Table 6 had the same composition as the 1K coating system shown in Table 4. Package II was made of 37% by weight of HDI trimer Desmodur0 N3300A available from Bayer and 63% by weight of organic solvents including butyl acetate (2%), ethylethoxy propionate (44%) and hydrocarbon solvent (17%). The mixing ratio of package I:package II was 4:1 by volume.

The mixed coating compositions were applied to test panels based on well known coating application process to form coatings. The coatings were exposed to UV irradiation with a UV light same as described in Comparative Examples 1 for 1 minutes (short time, Ex 7, Ex 8, and Ex 9) and 3 minutes (long time, Ex 7A, Ex 8A, and Ex 9A), respectively.

The resulted cured clearcoat showed increasing hardness with time (Table 6).

TABLE 6
Two K Coating Systems

| | Ex 7 | Ex 7A | Ex 8 | Ex 8A | Ex 9 | Ex 9A |
|---|---|---|---|---|---|---|
| Package I | | | | | | |
| Unsaturated | 28.13 | 28.13 | 28.13 | 28.13 | 12.50 | 12.50 |
| aliphatic urethane | | | | | | |
| acrylate Desmolux | | | | | | |
| XP 2513 | | | | | | |
| Unsaturated | 10.00 | 10.00 | 10.00 | 10.00 | 25.00 | 25.00 |
| aliphatic urethane | | | | | | |
| acrylate | | | | | | |
| DESMOLUX VP- | | | | | | |
| LS-2308 (80% | | | | | | |
| solid in 20% | | | | | | |
| HDDA) | | | | | | |
| Unsaturated | 16.67 | 16.67 | 16.67 | 16.67 | 22.50 | 22.50 |
| aliphatic urethane | | | | | | |
| acrylate XP-2654 | | | | | | |
| (60% SOLIDS in | | | | | | |
| 40% Butyl Acetate) | | | | | | |
| Hydroxyl-bearing | 10.00 | 10.00 | 10.00 | 10.00 | 2.00 | 2.00 |
| polyester | | | | | | |
| DESMOPHEN VP | | | | | | |
| LS-2089 | | | | | | |
| Photoinitiator | 1.50 | 1.50 | 3.00 | 3.00 | 2.10 | 2.10 |
| Irgacure 184 | | | | | | |
| Photoinitiator | 1.50 | 1.50 | 0 | 0 | 0.75 | 0.75 |
| Darocur 1173 | | | | | | |
| Photoinitiator | 0 | 0 | 0 | 0 | 0.15 | 0.15 |
| Darocur TPO | | | | | | |
| Light stabilizer | 0.25 | 0.25 | 0.25 | 0.25 | 0.25 | 0.25 |
| TINUVIN 384 | | | | | | |
| Light stabilizer | 0.25 | 0.25 | 0.25 | 0.25 | 0.25 | 0.25 |
| TINUVIN 292 | | | | | | |
| Flow additive BYK- | 0.25 | 0.25 | 0.25 | 0.25 | 0.25 | 0.25 |
| 333 | | | | | | |
| BUTTYL ACETATE | 31.46 | 31.46 | 31.46 | 31.46 | 34.25 | 34.25 |
| Total solids, | 100 | 100 | 100 | 100 | 100 | 100 |
| solvents and | | | | | | |
| additives (%) | | | | | | |
| Ready to spray | 50 | 50 | 50 | 50 | 50 | 50 |
| solids (%) | | | | | | |
| PERCENT - | 45 | 45 | 45 | 45 | 20 | 20 |
| Desmolux XP | | | | | | |
| 2513- SOLIDS | | | | | | |
| PERCENT VPLS- | 16 | 16 | 16 | 16 | 40 | 40 |
| 2308-SOLIDS | | | | | | |
| PERCENT XP- | 20 | 20 | 20 | 20 | 27 | 27 |
| 2654 SOLIDS | | | | | | |
| PERCENT | 15 | 15 | 15 | 15 | 3 | 3 |
| hydroxyl-bearing | | | | | | |
| polyester | | | | | | |
| DESMOPHEN VP | | | | | | |
| LS-2089 SOLIDS | | | | | | |
| PERCENT HDDA | 4 | 4 | 4 | 4 | 10 | 10 |
| SOLIDS | | | | | | |
| Package II | | | | | | |
| Isocyanate | I:II = 4:1 | I:II = 4:1 | I:II = 4:1 | I:II = 4:1 | I:II = 4:1 | I:II = 4:1 |
| Desmodur ® | by | by | by | by | by | by |
| N3300A 37% | Volume | Volume | Volume | Volume | Volume | Volume |
| SOLIDS | | | | | | |
| UV exposure time | 1 MIN | 3 MIN | 1 MIN | 3 MIN | 1 MIN | 3 MIN |
| FISCHER- | 17 | 26 | 14 | 19 | 17 | 36 |
| Hardness same | | | | | | |
| day (N/m2) | | | | | | |
| FISCHER- | 45 | 65 | 38 | 52 | 46 | 74 |
| Hardness 6-days | | | | | | |
| (N/mm²) | | | | | | |
| Tg (° C.) | 62 | 60 | 63 | 68 | n/a | n/a |

1. A coating composition comprising a component A comprising one or more monomers, oligomers, or polymers having one or more radiation crosslinkable functional groups D and one or more chemical crosslinkable functional groups X, wherein a layer of said coating composition applied over a substrate cures into a dry coating when exposed to actinic radiation and said dry coating has a glass transition temperature (Tg) between 15° C. to 120° C., wherein the one or more functional groups D are radiation crosslinkable ethylenically unsaturated double bonds and the functional groups X are one or more functional groups selected from hydroxyl, thiol, isocyanate, epoxy, acid, thioisocyanate, acetoacetoxy, carboxyl, amine, anhydride, ketimine, aldimine, or urethane group.

2. The coating composition of claim 1 further comprising:
(i) a component B comprising one or more monomers, oligomers, or polymers having one or more functional groups Y that react with the functional groups X to form crosslink;
(ii) a component C comprising one or more monomers, oligomers, or polymers having said one or more functional groups Y and said one or more functional groups D; or
(iii) a combination of the component B and C,
wherein said functional groups X and Y are pair wise selected from hydroxyl and isocyanate groups, thiol and isocyanate groups, epoxy and acid groups, epoxy and isocyanate groups, isocyanate and amine groups, or isocyanate and urethane groups.

3. The coating composition of claim 1 or 2, wherein the radiation crosslinkable ethylenically unsaturated double bonds are selected independently from acrylate unsaturated double bond, methacrylate unsaturated double bond, or a combination thereof.

4. The coating composition of claim 1 or 2, wherein said dry coating has a Tg between 25° C. to 100° C.

5. The coating composition of claim 1 or 2 comprising one or more photoinitiators.

6. The coating composition of claim 1 or 2 further comprising catalyst, rheology control agent, pigment, UV protection package, flow additives, or a combination thereof.

7. The coating composition of claim 1, wherein said coating composition is formulated as a one-package coating composition.

8. The coating composition of claim 2, wherein said coating composition is formulated as a two-package coating composition comprising a package I comprising the component A and a package II comprising said component B, said component C, or a combination of said components B and C.

9. A substrate coated with the coating composition of claim 1.

10. The substrate of claim 9, wherein said substrate is a vehicle, vehicle body, vehicle parts, or a combination thereof.

11. A method for coating a substrate comprising the steps of:
a) providing a coating composition, wherein said coating composition is selected from:
(i) a one-package coating composition comprising a component A comprising one or more monomers, oligomers, or polymers having one or more radiation crosslinkable functional groups D and one or more chemical crosslinkable functional groups X, wherein a layer of said one-package coating composition applied over a substrate cures into a dry coating when exposed to actinic radiation, wherein the one or more functional groups D are radiation crosslinkable ethylenically unsaturated double bonds and the functional groups X are one or more functional groups selected from hydroxyl, thiol, isocyanate, epoxy, acid, thioisocyanate, acetoacetoxy, carboxyl, amine, anhydride, ketimine, aldimine, or urethane group; or
(ii) a two-package coating composition prepared by mixing a package I and a package II, wherein said package I comprises the component A, and said package II comprises:
(1) a component B comprising one or more monomers, oligomers, or polymers having one or more functional groups Y that react with the functional groups X to form crosslink;
(2) a component C comprising one or more monomers, oligomers, or polymers having said one or more functional groups Y and said one or more functional groups D; or
(3) a combination of the component B and C;
wherein said functional groups X and Y are pair wise selected from hydroxyl and isocyanate groups, thiol and isocyanate groups, epoxy and acid groups, epoxy and isocyanate groups, isocyanate and amine groups, or isocyanate and urethane groups;
b) applying the coating composition to the substrate to form a coating layer;
c) irradiating the coating layer with actinic radiation to form a dry coating on said substrate.

12. The method of claim 11, wherein the functional groups D are selected from radiation crosslinkable acrylate unsaturated double bond, methacrylate unsaturated double bond, or a combination thereof.

13. The method of claim 11 further comprising the step of curing the coating layer at ambient temperature when said two-package coating composition is selected.

14. The method of claim 11, wherein said two-package coating composition is prepared by mixing the package I and the package II in a container before spraying.

15. The method of claim 11, wherein said two-package coating composition is prepared by mixing the package I and the package II during spraying.

16. A substrate coated by the method of claim 11.

17. (canceled)
